(19) United States
(12) Patent Application Publication
(10) Pub. No.: US 2009/0028680 A1
(43) Pub. Date: Jan. 29, 2009

(54) Intermediate apparatus for towing utility vehicles

(76) Inventor: Troy L. Kling, Fort Lupton, CO (US)

Correspondence Address: The Law Firm Of;HAROLD A. BURDICK, Suite E, 6676 Gunpark Drive, Boulder, CO, 80301, US

(21) Appl. No.: 11/881,470

(22) Filed: Jul. 27, 2007

(51) Int. Cl. B60P 3/12

(52) U.S. Cl. 414/563

(57) ABSTRACT

Apparatus are disclosed for towing utility vehicles such as motorized luggage carriers. The apparatus includes a base framework having spaced axle mounts at one end and a hitch structure at the other. A lift frame is supported on the base framework and includes a sloped guide beam and a winch operational support assembly for cable operations in line with the guide beam. The guide beam has a linear portion and an arcuate distal end portion, a slide frame being mounted over the guide beam and associated with the operational support assembly to cause movement of the slide frame along the guide beam. A transverse beam is mounted at the slide frame and provides securement structure at the utility vehicle. A plurality of catches are located along the guide beam, and a latch is located at the slide frame for capture by the catches as the slide frame is moved in one direction on the guide beam and release therefrom upon movement in an opposite direction. A plurality of slide frame guide pins accommodates different presentments of the transverse beam at different slide frame locations along the guide beam.

### FIELD OF THE INVENTION

This invention relates to towing apparatus, and, more particularly, relates to non-motorized apparatus for towing utility vehicles such as luggage dolly tow motors and/or luggage belt loaders that have low clearance, long wheel base, increased weight or the like.

### BACKGROUND OF THE INVENTION

Breakdown of low clearance, long wheelbase, over-weight vehicles and the like present a difficult towing problem, particularly at busy and congested sites such as landing fields. These vehicles require towing structures capable of addressing vehicle weight and/or vehicle configuration during loading on the towing structure, elevation of the vehicle and towing of the vehicle from one location to another.

In addition, safety of personnel loading (chaining or the like) the vehicle to the towing structure must be addressed. Also, since many such towing structures are intermediate (i.e., are themselves towed by a motorized vehicle using, for example, a towing hitch), the towing structures must be configured with concern for the integrity (tires, hitches, bumpers and the like) of the towing vehicle.

Moreover, the towed vehicle must be carried by the towing structure so that the towing structure itself is not damaged during transport. In this regard it is particularly important that towing structure tires be protected and that towing structure stability is maintained during transport. Various intermediate towing structures have been heretofore suggested and/or utilized for towing trucks, automobiles and the like (see U.S. Pat. Nos. 3,896,949, 3,720,330, 3,703,240, 3,784,036 and 3,627,154 for example). These structures have not, however, successfully addressed the concerns aforementioned, and most particularly so when the towed vehicle has a difficult configuration.

### SUMMARY OF THE INVENTION

This invention provides an improved intermediate towing apparatus for towing utility vehicles that have low clearance, long wheelbases, are over-weight and/or present other difficult configurations (such as luggage handling utility vehicles) and that is adapted for use at busy and congested sites such as landing fields. The towing apparatus is configured to manipulate towed vehicles having difficult configurations safely at all stages of operation (loading, elevation and transport), and to protect apparatus components and maintain apparatus stability during transport. The apparatus of this invention is particularly well adapted for use in towing motorized airport luggage utility vehicles.

The apparatus includes a base framework having spaced axle mounts at one end and a hitch structure at the other. A lift frame is supported on the base framework and includes a sloped guide beam and a winch operational support assembly for cable operations in line with the guide beam. The guide beam has a linear portion and an arcuate distal end portion. A slide frame is mounted over the guide beam and associated with the operational support assembly to cause movement of the slide frame along the guide beam. A transverse beam is mounted at the slide frame and provides securement at the utility vehicle.

Base framework mobility is provided by an axle and wheel assembly held at the axle mounts. The sloped guide beam includes a plurality of catches located at different intervals in the linear portion thereof. A latch is located with the slide frame and is configured for capture at the catches of the linear portion of the guide beam when the slide frame is moved in one direction on the guide beam, the latch prohibiting further movement in the one direction when the latch is captured by any one of the catches. The latch is released from the catches upon movement in an opposite direction.

The base framework of the apparatus preferably includes a stabilizer plate positioned between the spaced axle mounts. The lift frame preferably includes an upright connected with the base framework, the sloped guide beam extending between the upright and the stabilizer plate. The linear portion of the guide beam is provided with a cable anchor and cable guide at an end opposite the distal end portion, and a winch assembly is mounted at the upright. The slide frame preferably includes a slide framework portion and a channel extension framework portion configured to extend above and adjacent to one end of the slide framework portion. A cable orienting portion is located at the extension framework portion.

First and second orienting guides are located at the slide framework portion with the first orienting guide contacting and guiding travel at the linear portion of the guide beam to achieve a first orientation of the slide frame relative to the guide beam. The second orienting guide contacts and guides travel at the arcuate distal end portion of the guide beam to achieve a second orientation of the slide frame relative to the guide beam.

It is therefore an object of this invention to provide an intermediate towing apparatus for towing utility vehicles having difficult configurations.

It is another object of this invention to provide an intermediate towing apparatus that is adapted for use at busy and/or congested sites such as landing fields.

It is still another object of this invention to provide an intermediate towing apparatus that is configured to manipulate towed vehicles having difficult configurations safely at all stages of operation (loading, elevation and transport), and protect apparatus components and maintain apparatus stability during transport.

It is another object of this invention to provide an intermediate towing apparatus for towing utility vehicles having difficult configurations, the apparatus including a base framework with spaced axle mounts at one end and a hitch structure at an opposite end, a lift frame mounted on said base framework and including a sloped guide beam and a winch operational support assembly for cable operations in line with the guide beam, the guide beam including a linear portion and an arcuate distal end portion, and a slide frame mounted over the guide beam and associatable with the operational support assembly for slidable movement of the slide frame along the guide beam, the slide frame having a transverse beam mounted thereat for securement at the utility vehicle.

It is still another object of this invention to provide an intermediate towing apparatus for towing utility vehicles having at least one of low clearance, long wheelbase or heavy weight, the apparatus including a base having wheels and a hitch structure, a lift frame mounted on said base including a sloped guide beam and a winch operational support assembly for cable operations in line with the guide beam, the guide beam including a linear portion and an arcuate distal end portion, the linear portion having a plurality of catches located at different intervals, and a slide frame mounted over the guide beam and associatable with the operational support assembly for slidable movement of the slide frame along the guide beam, the slide frame having a transverse beam mounted thereat for securement at the utility vehicle and a latch configured for capture at the catches of the linear portion of the guide beam when the slide frame is moved in one direction on the guide beam and for release from the catches when moved in an opposite direction, the latch prohibiting further movement in the one direction when the latch is captured by any one of the catches.

It is yet another object of this invention to provide an intermediate towing apparatus for towing airport luggage utility vehicles, the apparatus including a base framework including a stabilizer plate and spaced axle mounts at one end and a hitch structure at an opposite end, an axle and wheel structure received at the axle mounts, a lift frame including an upright connected with the base framework and a sloped guide beam extending between the upright and the stabilizer plate of base framework, the guide beam having a linear portion and an arcuate distal end portion, the linear portion having a cable anchor and cable guide at an end opposite the distal end portion, a winch assembly being mounted at the upright, and a slide frame having a slide framework portion and a channel extension framework portion configured to extend above and adjacent to one end of the slide framework portion, a cable orienting portion located at the extension framework portion, the slide framework portion mounted over the guide beam for slidable movement of the slide frame along the guide beam and having first and second orienting guides thereat, the first orienting guide contacting and guiding travel at the linear portion of the guide beam to achieve a first orientation of the slide frame relative to the guide beam, and the second orienting guide contacting and guiding travel at the arcuate distal end portion of the guide beam to achieve a second orientation of the slide frame relative to the guide beam.

With these and other objects in view, which will become apparent to one skilled in the art as the description proceeds, this invention resides in the novel construction, combination, and arrangement of parts substantially as hereinafter described, and more particularly defined by the appended claims, it being understood that changes in the precise embodiment of the herein disclosed invention are meant to be included as come within the scope of the claims.

### BRIEF DESCRIPTION OF THE DRAWINGS

The accompanying drawings illustrate a complete embodiment of the invention according to the best mode so far devised for the practical application of the principles thereof, and in which:

FIG. 1 is a perspective view of the apparatus of this invention in use;

FIG. 2 is a top view of the apparatus of this invention;

FIG. 3 is a front view of the apparatus of FIG. 2;

FIG. 4 is a rear view of the apparatus of FIG. 2;

FIG. 5 is a sectional view taken through section lines 5-5 of FIG. 2;

FIG. 6 is an exploded perspective view of the apparatus of this invention;

FIGS. 7A through 7C are partial side view illustrations showing various stages of operation of the apparatus of this invention; and

FIG. 8 is a partial side sectional view illustrating a second embodiment of the apparatus of this invention.

### DESCRIPTION OF THE INVENTION

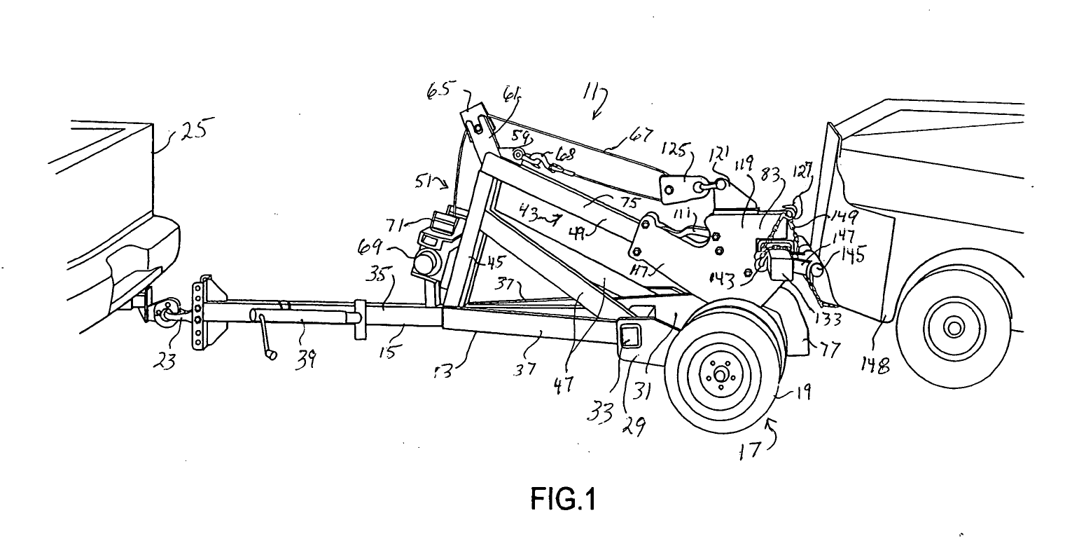

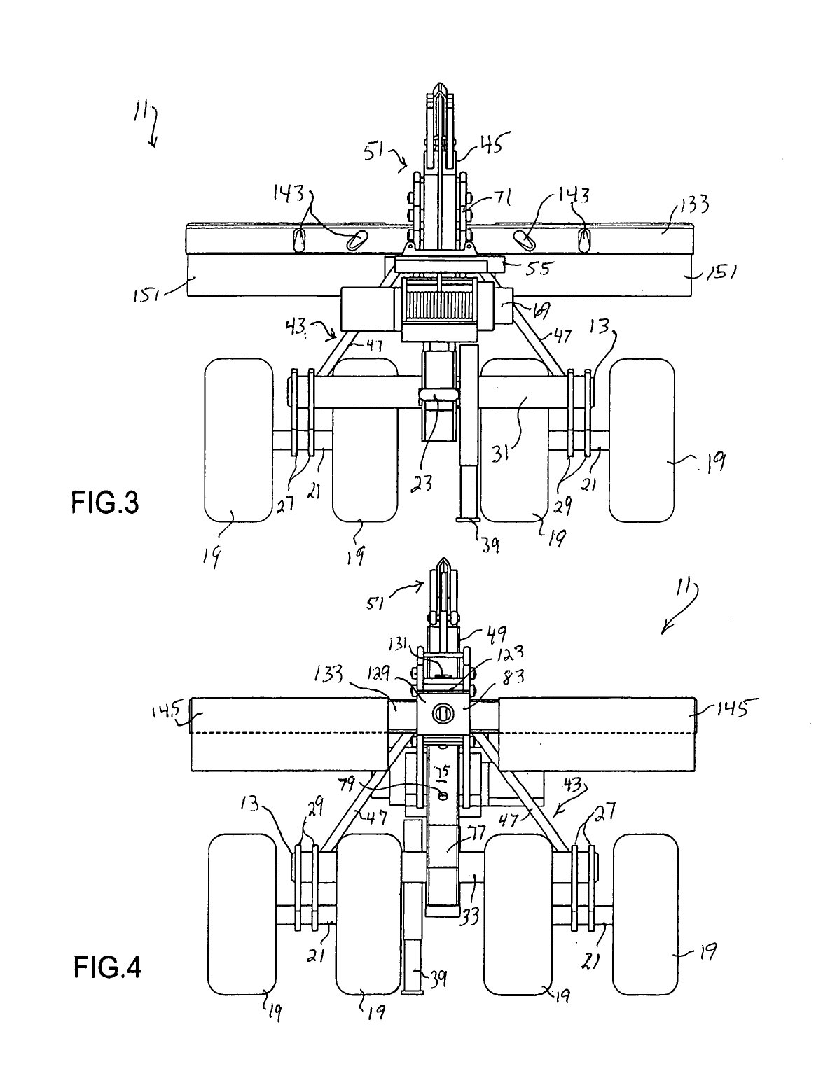

Referring to FIGS. 1 through 6, a first embodiment of this invention is described that is particularly adapted for retrieval of stranded utility vehicles having difficult configurations, for example motorized luggage handling vehicles such as belt loaders and dolly towers.

As shown in FIG. 1, intermediate apparatus 11 is a tow behind structure (i.e., requires a truck or other vehicle to tow it). As shown in FIGS. 1, 2, 5 and 6, apparatus 11 includes base 13 having a framework 15 made of structural iron or steel beams and plate material, such as square iron tubing and flat plate, for example, joined by common methods (including welding, bolting and the like). Wheel and axle structure 17, including wheels/tires 19 mounted on axles 21, and hitch structure 23 for mounting to a towing vehicle 25, are maintained at frame 15 using known methods (FIG. 1).

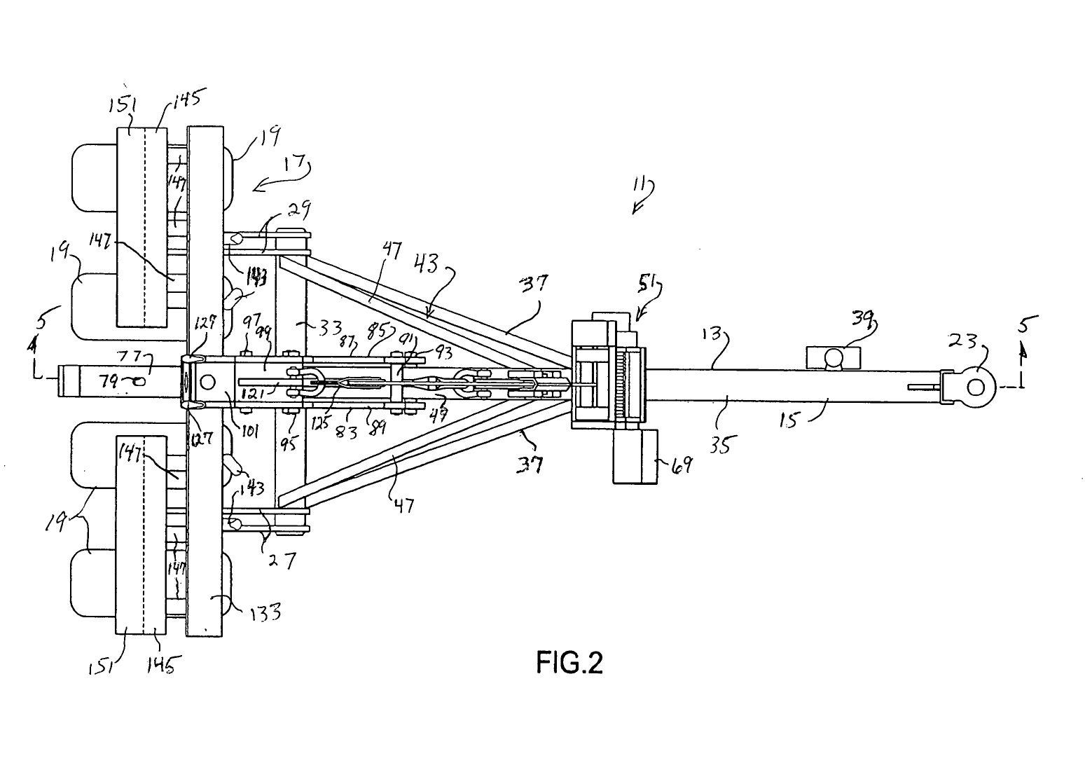

Axle mounts 27 and 29 and stabilizer plate 31 are connected (welded, for example) at the rear of framework 15 with beam support 33. Beam support 33 and stabilizer plate 31 are connected (welded) with one end of beam support 35, hitch structure 23 located at the opposite end. Axles 21 are mounted through openings 36 in mounts 27 and 29 and wheel/tires 19 are mounted on the axles as is conventional. Bracing struts 37, welded to beam supports 33 and 35, support the outer ends of beam support 33. Height adjustable pivotable supporting leg 39 is located adjacent to hitch structure 23 at beam support 35 for base position retention when not attached to a towing vehicle (stored position shown in FIG. 1 and deployed position shown in FIGS. 2 through 5).

Lift frame 43 (made of structural iron or steel beams and plate material, such as square iron tubing and flat plate, for example, joined and secured using known techniques such as welding or the like) is connected to base framework 15 and includes upright 45 attached to beam 35 which is connected to the ends of support beams 47, beams 47 anchored at their opposite ends to beam 33 of base framework 15. Sloped guide beam 49 is connected between upright 45 and stabilizer plate 31.

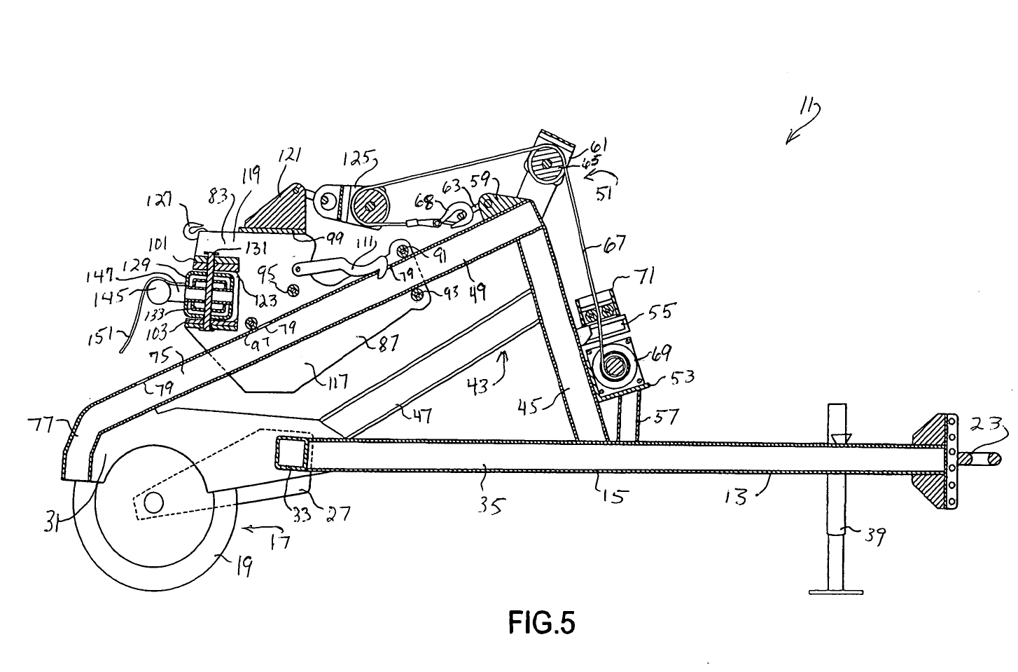

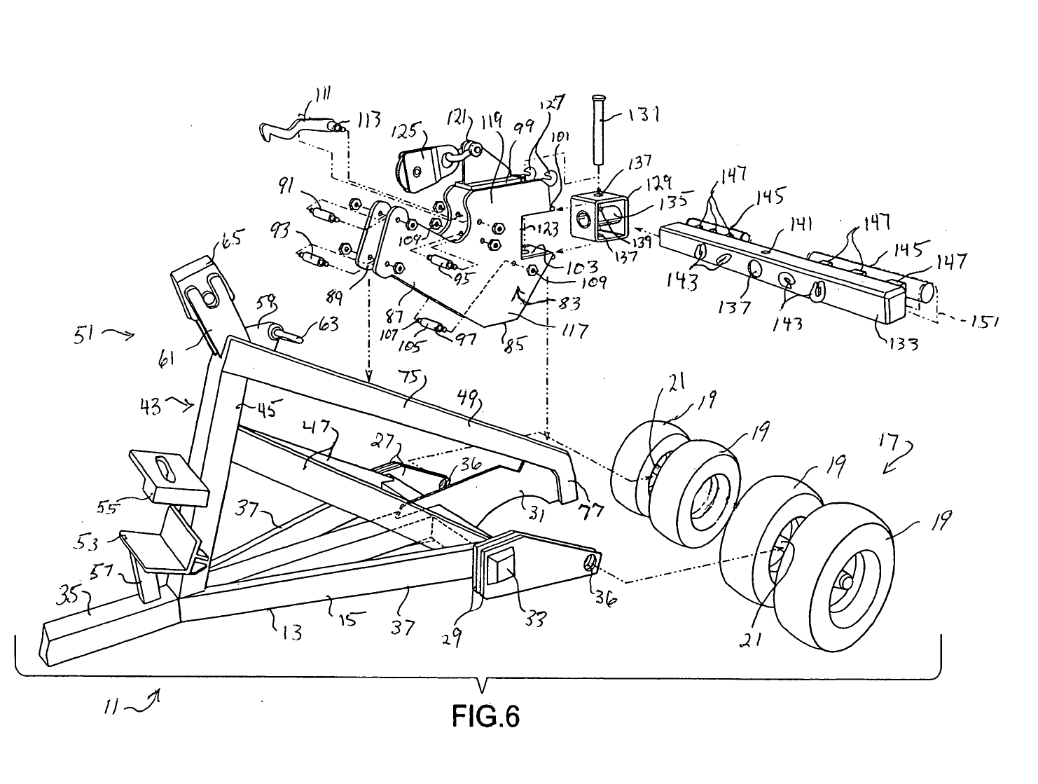

Winch operational support assembly 51 (see FIGS. 5 and 6) includes winch motor and ratchet mounting platforms 53 and 55 connected to upright 45, motor platform 53 further supported by support leg 57 connected thereto and to beam 35. Cable anchor 59 and cable guide 61 of support assembly 51 are connected with guide beam 49 at one end thereof, anchor 59 including a pivotable cable hook receiving eye 63 and guide 61 including pulley block 65. This arrangement accommodates manipulation of cable 67 (threaded around pulley 65 and, after further routing discussed hereinbelow, connected to eye 63 by safety hook 68) using a winch assembly (a motor 69 and fair lead 71) in line with guide beam 49. The winch assembly is provided with a safety release for directional selection, and is preferably operated by a pendant remote control, thus allowing all operations of apparatus 11 to be conducted by a single worker.

Guide beam 49 is characterized by linear portion 75 and arcuate distal end portion 77. Linear portion 75 has a plurality of catches 79 formed therein (openings in the top of the square tube forming beam 49 for example—see FIG. 5). Arcuate end portion 77 safely and stabily guides movement of slide frame 83 to a position low to the ground accommodating low clearance vehicles as will be described in greater detail hereinafter.

Slide frame 83 (an assembly made of iron or steel beam and plate material as well as various steel tubing, rods and pins, joined using conventional welding and connector techniques) includes framework 85 formed by panels 87 and 89 held in a spaced relationship by guide pins 91, 93, 95 and 97 and plate supports 99, 101 and 103 (see FIGS. 2, 5 and 6). Pins 91 through 97 preferably include roller bodies 105 on axles 107 threaded at both ends and held by nuts 109 (see, for example, pin 97 in FIG. 6, the remaining pins having a similar construction). Latch hook 111 is mounted for pivotable movement between plates 87 and 89 on a similarly constructed pin assembly 113.

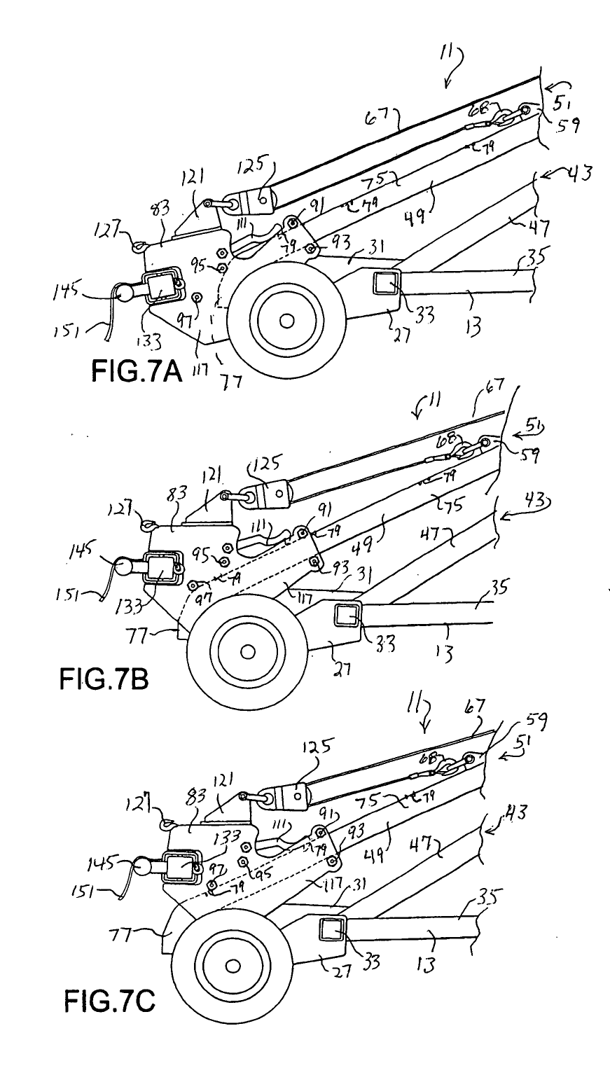

Latch hook 111 is oriented and configured so that it is captured by catches 79 as slide frame 83 descends on guide beam 49 under control of the winch assembly. If it is not desired that latch hook 111 be captured by any particular catch 79 during descent, it must be manually biased out of contact with beam 49 (a lever could be provided for this purpose). Operation of the winch assembly to cause ascension of frame 83 results in automatic release of hook 111 from catches 79 in passing. In this way, the capture of hook 111 by the lowermost of catches 79 prevents further movement of slide frame 83 towards the ground thereby allowing a worker to safely manipulate chains and the like therebeneath (see FIG. 7A) and relieving stress at cable 67 during such operations. Capture of hook 111 in the middle one of catches 79 relieves the strain on cable 67 during transport so that the weight of the towed vehicle is not carried on the cable (see FIG. 7C). Capture of hook 111 in the uppermost catch 79 likewise takes the strain off cable 67 when apparatus 11 is idle (as shown in FIG. 5).

Framework 85 is characterized by a slide framework portion 117 and a channel extension framework portion 119 extending above and adjacent to one end of portion 117. Cable orienting plate 121 is connected at portion 119 and a channel framework 123 is defined by supports 101 and 103 and a cutout in each of panels 87 and 89 at framework portion 119 (see FIGS. 5 and 6). Pulley block 125 is pivotably connected at plate 121 and has cable 67 threaded therethrough for movement of slide frame 83 along guide beam 49. Chain securing hooks 127 are located adjacent to plate 121.

As shown in FIGS. 4 through 6, channel joint 129 is articulatably maintained in channel framework 123 by virtue of its smaller cross section and central mounting pin 131. Transverse beam 133 is articulatably mounted through joint 129 by virtue of its smaller cross section, beam 133 located on center pin 135 (a tubing welded in joint 129) through central opening 137 in beam 133. Pin 131 is mounted through joint 129, beam 133 and pin 135 through openings 137, 139 and 141, respectively (see FIG. 6). As may be appreciated, this arrangement allows articulation of beam 133 in at least two planes (within structural limitations)

Transverse beam 133 has a plurality of chain securing hooks 143 at one side thereof, and draw bars 145 mounted at an opposite side thereof in a spaced relationship on mounting arms 147. Draw bars 145 are snugged against vehicle 148 (FIG. 1) by chains 149, and may contact the vehicle at or beneath the frame thereof due to its low presentment during the vehicle loading stage as described hereinafter. Bumper pads 151 are applied on draw bars 149 to prevent surface marring of towed vehicles.

Turning now to FIGS. 7A through 7C, operation of apparatus 11 will be described which allows for low presentment of vehicle securing beam 133 and draw bars 145. Slide frame 83 is mounted with guide pins 91 and 93 above and below, respectively, guide beam 49. When slide frame 83 is traveling on linear portion 75 of guide beam 49, guide pin 97 contacts beam 49 and guides and stabilizes slide frame 83 thereon (FIG. 7C). As slide frame 83 is lowered by the winch assembly on guide beam 49, this arrangement remains as frame 83 approaches arcuate distal end portion 77 (FIG. 7B) and thus a first orientation of the slide frame relative to beam 49 is maintained with the transverse beam 133 and draw bars 146 assembly substantially parallel to the ground.

When frame 83 is lowered past the juncture of linear portion 75 and end portion 77, guide pin 97 gradually ceases contact with guide beam 49, and guide pin 95 comes into contact therewith guiding and stabilizing slide frame 83 as it travels around arcuate end portion 77 (FIG. 7A). Because of the arcuate travel of slide frame 83 at end portion 77 and because of the differing linear position of guide pin 95 relative to guide pin 97, a second orientation of the slide frame relative to guide beam 49 is achieved during this stage of travel, with transverse beam 133 and draw bars 145 tipped toward the ground thus lowering their presentment at a vehicle to be loaded.

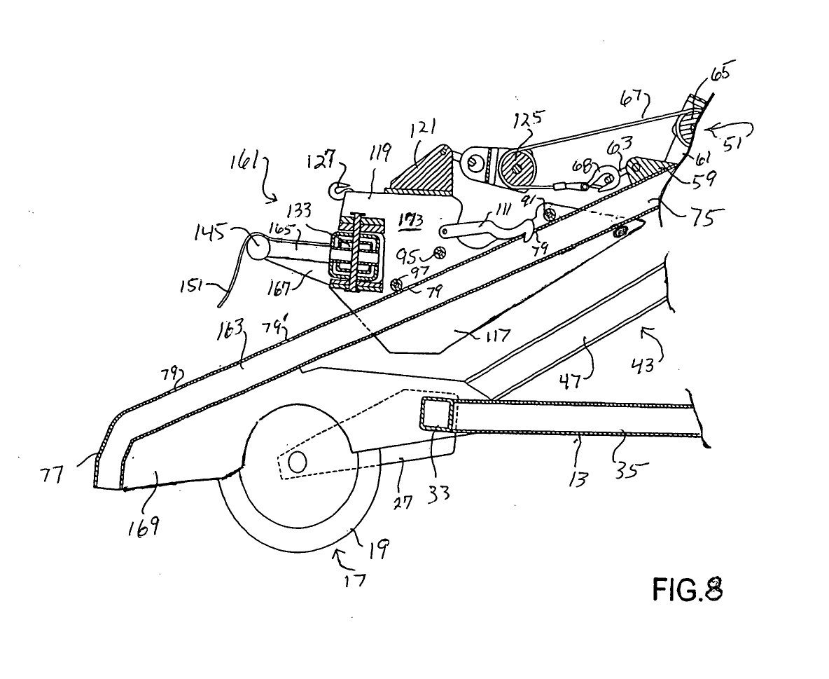

FIG. 8 shows an alternative embodiment 161 of the apparatus of this invention that is similar in most regards to embodiment 11 of the apparatus (identical numerical identification is utilized herein for elements common to both embodiments, only the differences hereinafter described). In this embodiment, guide beam 163 has an elongated linear portion 75 to achieve an even lower presentment of the slide frame as well as a greater separation of the towed vehicle from apparatus 161 (thus accommodating manipulation of vehicles with exceptionally long wheelbases such as luggage belt loaders). In furtherance of this embodiment, arms 165 connecting draw bars 145 to transverse beam 133 are elongated and an additional catch 79′ is added for capture of hook 111 during vehicle transport. Due to the added length of arms 165, support plates 167 are attached to each end of draw bars 145 (only one shown in FIG. 8), plates 167 also connected with transverse beam 133. Stabilizer plate 169 is also elongated to accommodate attachment of the elongated guide beam 163. Additionally, pin 171 is repositioned to allow for the longer reach required by slide frame 173, and slide frame 173 is elongated at its rear accordingly.

As may be appreciated from the foregoing, an improved intermediate towing apparatus is provided by this invention that has particularly useful applications for towing vehicles with difficult geometry or other configuration. In place of the electric winch assembly, a hydraulically driven hoist could be utilized. The apparatus is made of tough and durable materials and is adaptable for a variety of vehicle types. The apparatus is configured to provide utmost safety for workers utilizing the apparatus both during towed vehicle loading and transport. A minimum of loading is maintained on winch cables during vehicle loading, transportation and

What is claimed is:

1. An intermediate towing apparatus for towing utility vehicles having difficult configurations, said apparatus comprising:
a base framework including spaced axle mounts at one end and a hitch structure at an opposite end;
a lift frame supported on said base framework and including a sloped guide beam and a winch operational support assembly for cable operations in line with said guide beam, said guide beam including a linear portion and an arcuate distal end portion; and
a slide frame mounted over said guide beam and associatable with said operational support assembly for slidable movement of said slide frame along said guide beam, said slide frame having a transverse beam mounted thereat for securement at the utility vehicle.

2. The apparatus of claim 1 wherein said slide frame includes a channel, said transverse beam mounted through and secured at said channel, said channel and beam configured and secured so that articulating movement of said transverse beam is accommodated within structural limitations.

3. The apparatus of claim 1 wherein said slide frame includes upper and lower guide pins spaced to receive said guide beam therebetween.

4. The apparatus of claim 1 wherein said slide frame includes first and second orienting guides, said first orienting guide contacting and guiding travel at said linear portion of said guide beam to achieve a first orientation of said slide frame relative to said guide beam, and said second orienting guide contacting and guiding travel at said arcuate distal end portion of said guide beam to achieve a second orientation of said slide frame relative to said guide beam with said transverse beam tipped.

5. The apparatus of claim 4 wherein said transverse beam has a draw bar mounted thereat and spaced therefrom for contacting the utility vehicle at or beneath a frame member thereof, said draw bar tipped toward the ground in said second orientation.

6. The apparatus of claim 1 wherein said slide frame includes a slide framework portion and a channel extension framework portion configured to extend above and adjacent to one end of said slide framework portion when said slide frame is mounted on said guide beam, a cable orienting portion located at said extension framework portion.

7. An intermediate towing apparatus for towing utility vehicles having at least one of low clearance, long wheelbase or heavy weight, said apparatus comprising:
a base including wheels and a hitch structure;
a lift frame mounted with said base and including a sloped guide beam and a winch operational support assembly for cable operations in line with said guide beam, said guide beam including a linear portion and an arcuate distal end portion, said linear portion having a plurality of catches located at different intervals; and
a slide frame mounted over said guide beam and associatable with said operational support assembly for slidable movement of said slide frame along said guide beam, said slide frame having a transverse beam mounted thereat for securement at the utility vehicle and a latch configured for capture at said catches of said linear portion of said guide beam when said slide frame is moved in one direction on said guide beam and for release from said catches when moved in an opposite direction, said latch prohibiting further movement in said one direction when said latch is captured by any one of said catches.

8. The apparatus of claim 7 wherein said slide frame has a joint articulatably maintained thereat, said transverse beam mounted through said joint and secured thereat at a center pin, said joint and center pin configured so that articulating movement of said transverse beam in at least two planes is accommodated.

9. The apparatus of claim 8 wherein said slide frame includes a channel framework, said joint mounted in said channel framework by a central pin, said central pin receivable through said transverse beam and said center pin.

10. The apparatus of claim 7 wherein said base includes a stabilizer plate and wherein said lift frame includes an upright, said guide beam mounted between said upright and said stabilizer plate.

11. The apparatus of claim 10 wherein said base includes first and second beam supports, said first beam support having said hitch structure at one end thereof and said second beam support transversely affixed at an opposite end thereof, said second beam support having axle mounts located at the ends thereof with said stabilizer plate attached to said beam supports therebetween.

12. The apparatus of claim 7 wherein said transverse beam has a draw bar mounted at one side thereof and spaced therefrom for contacting the utility vehicle at or beneath a frame member thereof, and securement hooks mounted at an opposite side thereof.

13. The apparatus of claim 12 wherein said slide frame has securement hooks mounted at an upper portion thereof above said transverse beam.

14. An intermediate towing apparatus for towing airport luggage utility vehicles, said apparatus comprising:
a base framework including a stabilizer plate and spaced axle mounts at one end and a hitch structure at an opposite end;
an axle and wheel structure received at said axle mounts;
a lift frame including an upright connected with said base framework and a sloped guide beam extending between said upright and said stabilizer plate of base framework, said guide beam having a linear portion and an arcuate distal end portion, said linear portion having a cable anchor and cable guide at an end opposite said distal end portion, a winch assembly being mounted at said upright; and
a slide frame having a slide framework portion and a channel extension framework portion configured to extend above and adjacent to one end of said slide framework portion, a cable orienting portion located at said extension framework portion, said slide framework portion mounted over said guide beam for slidable movement of said slide frame along said guide beam and having first and second orienting guides thereat, said first orienting guide contacting and guiding travel at said linear portion of said guide beam to achieve a first orientation of said slide frame relative to said guide beam, and said second orienting guide contacting and guiding travel at said arcuate distal end portion of said guide beam to achieve a second orientation of said slide frame relative to said guide beam.

15. The apparatus of claim 14 wherein said slide framework portion of said slide frame has upper and lower guide pins spaced to receive said guide beam therebetween.

16. The apparatus of claim 14 wherein said linear portion of said guide beam has a plurality of catches located at different intervals, and wherein said a slide frame has a pivotable latch configured for capture at said catches of said linear portion of said guide beam when said slide frame is moved in one direction on said guide beam and for release from said catches when moved in an opposite direction.

17. The apparatus of claim 14 further comprising a height adjustable pivotable support leg mounted adjacent to said hitch structure at said base framework.

18. The apparatus of claim 14 wherein said slide frame has a transverse beam mounted at said channel extension framework portion.

19. The apparatus of claim 18 wherein said transverse beam has a draw bar mounted thereat and spaced therefrom for contacting the utility vehicle at or beneath a frame member thereof.

20. The apparatus of claim 18 wherein said slide frame includes a channel joint articulatably maintained at said channel extension framework portion, said transverse beam mounted through said channel joint and secured thereat by a center pin, said channel joint and center pin configured so that articulating movement of said transverse beam in at least two planes is accommodated.
